(19) United States
(12) Patent Application Publication
(10) Pub. No.: US 2016/0217136 A1
(43) Pub. Date: Jul. 28, 2016

(54) SYSTEMS AND METHODS FOR PROVISION OF CONTENT DATA

(71) Applicant: ITAGIT TECHNOLOGIES FZ-LLC, Dubai OT (AE)

(72) Inventor: Adham Maghraby, Cairo (EG)

(73) Assignee: ITAGIT TECHNOLOGIES FZ-LLC, Dubai OT (AE)

(21) Appl. No.: 14/603,095

(22) Filed: Jan. 22, 2015

(51) Int. Cl. G06F 17/30

(52) U.S. Cl. CPC G06F 17/30053; G06F 17/30752

(57) ABSTRACT

A method for provision of content data is disclosed. A user is registered by a computer system. An operator of the computer system selects a radio or music station. The computer system is configured to receive and read an audio feed from said radio or music station. The audio feed is transcoded by the computer system. The audio feed is then recorded by said computer system. The computer system then saves the time and hash codes stamped files into a content database. The computer system matches said time and hash codes stamped files with songs in a pre-existing audio signature database. The computer system then receives content identification data from said pre-existing audio signature database. The computer system then records said received content identification data in said content database. The computer system then sends said content identification data to a mobile application located on a mobile device of said user.

### FIELD OF INVENTION

The present application relates to systems and methods for provision of content data, and in particular to systems and methods for providing content data to users in response to electronic tagging by users of broadcasted or distributed audio/video live or prerecorded content from all media source types.

### BACKGROUND

The explosive user adoption of digital devices globally, the continued expansion of the worldwide internet infrastructure, the increased production rate of all forms of digital content and explosive uptake of social media services worldwide have all contributed to the exponential growth of digital content consumption worldwide in all its forms; analogue and digital. Users, globally, are always seeking faster, easier and more efficient methods to interact, identify, capture, download and share their favorite content as they see it in real-time on their different media sources, be it radio, TV, cable, satellite, IP streams or even content they saw or heard during any type of live event, whether that was a concert or a football game at the stadium.

### SUMMARY OF THE INVENTION

The present application relates to a computer system that allows serving and satisfying the growing needs of multimedia consumers. The computer system is made up of one or more computers that offers the embodiments that would service the ability of registered users all over the world to have the ability to digitally tag, from any electronic media device, in real-time, any specific content including but not limited to music, images, text, ringtones, products or services, electronic dance music, music information, music lyric, film and video, motion pictures, television, product or service identifications, product or service advertisements, product or service logos, or any other type of data describing the categories previously listed. This content can also include voice data, multimedia data, or any other suitable audio or visual data which may be provided to a user via a communication network, as this content is broadcasted or distributed via any form including but not limited to TV or radio broadcasting, by air, satellite, internet or cable.

A computer system consisting of multiple computers and servers is able to integrate with different methods of media broadcasting (air, satellite, cable or internet) distributing both live or pre-recorded audio\video content. Said computer system is able to process all forms of live and pre-recorded multimedia content (where said processing can include capturing, recording, transcoding, streaming, internally or externally mapping, time marking, and identifying), allowing users all over the world the unique ability to digitally tag, using an electronic media device, specific content pieces as they are broadcasted and distributed in real-time across different media types at the time that the user is exposed to that media type. In response to the tags sent by the user's electronic media device to the computer system by means of a Hypertext Transfer Protocol (“HTTP”) request, a short message service (“SMS”) message, radio frequency identification designation (“RFID”), near-field communication (“NFC”), optical signal locator (“OSL”) or other electrical, radio, optical or mechanical impulses, the computer system carries out the timely provisioning and delivery of specific broadcasted or distributed content to the user's electronic media device or other devices selected by the user.

### BRIEF DESCRIPTION OF THE DRAWINGS

Embodiments of the present application are illustrated by way of example in the accompanying figures, in which like reference numbers indicate similar elements, and in which:

FIG. 1 is a flow diagram illustrating a first exemplary method for content data provision according to a first embodiment of the present application;

FIG. 2 is a continuation of the flow diagram illustrating first exemplary method for content data provision of FIG. 1;

FIG. 3 is a flow diagram illustrating a second exemplary method for content data provision according to a second embodiment of the present application; and

FIG. 4 is a flow diagram illustrating a third exemplary method for content data provision according to a third embodiment of the present application.

### DETAILED DESCRIPTION OF THE INVENTION

The current invention performs the music identification process on the backend of the platform. This results in the music identification process no longer being user based. This in turn allows for a speedier and more efficient consumer experience.

The current invention interfaces with the select top radio and music TV stations that already enjoy a larger loyal viewer and listenership user base. The invention offers the natural evolution of the content exposure experience. It is the ultimate support function to these consumers, allowing for a fast, efficient and seamless interactive experience based on their real time, impulse behavior they experience when emotionally motivated to make a purchase by hearing their favorite tracks.

Existing services do not allow for retroactive identification of previously played tracks on these top radio and music TV stations. Existing services typically only allow for the identification of currently playing tracks and only if the user activates the identification feature. The current invention allows the consumer to view, preview and capture any of the tracks that were previously aired during the last 24 hours of any of the select radio and music TV stations. This allows for complete interactive emersion by the user with his or her favorite music station.

Radio stations and music TV stations face economic problems due to the rise of digital media consumption. The current invention alleviates this problem, as it allows them to offer to their listeners and viewers a new and immersive experience and allows them to generate new and incremental revenues from their operation. The platform offers a partial solution to a very critical problem for these media stations. The current invention also offers a new and incremental revenue stream to content labels, which remain locked in the old conventional model that governs their relationship with radio and music TV stations, a model based on revenues being generated from broadcast rights only. The current invention allows for this relationship to evolve naturally as it builds on the existing relationships and takes them to the next natural evolution of the user-media-content interactive experience.

The current invention also solves a big data problem for media stations and content labels alike. As existing music ID services are user based, media stations and content labels are not aware of the impact that these services are having on their operations. The media stations are not aware how many of the tracks they play are ID by users and they do not gain any revenues from these services. The current invention brings in music stations into this user interactive process and allows them access to new user based consumer data that would be used to drive the efficiency of their operation and their choice of tracks played.

An additional advantage is that the music industry is still experimenting with various monetization models for digital delivery. The most successful model has been the pay per download model via massive digital online content aggregators and via mobile transactions. The current invention drives this success further as it builds on existing successful monetization models.

The current invention also drives new user experiences that help deliver new monetization tools to the live entertainment industry in general.

User interactivity with live events has always been limited to capturing select moments via their mobile phone camera either in still images or short form video. This limitation has left a huge opportunity untouched for both the user and the event producer. The current invention offers a new mobile based solution that offers a new monetization advantage to event producers while solving the problem of real time interactivity with highlighted content experienced during an event. The user is now able to capture real time moments of the content played out during the event in a professional manner without having to fall back onto user generated videos that do not offer the real experience.

The current invention also offers the opportunity for users not attending a particular live event to interact with the content of the event in real time, even though the users may be in a different geographic location. This solves multiple existing user based problems and challenges of always being in touch with your favorite live events even if the user can't actually attend the event. This in turn offers new and exciting monetization opportunities for the event producers as they begin to offer new and innovative ways for the world to experience and interact with any given live event anywhere in the world.

The current invention also solves the problem of real time user interactivity and capture of live TV moments and sharing across social media platforms. Every individual views content on TV according to their preference, and the current invention offers the unique ability to allow viewers to capture in real time what they decide to be a highlight worth capturing and worth sharing. This solves a real time interactivity problem that used to be addressed by using a VCR. However, the old methods did not address the content producer's or broadcaster's opportunity to obtain additional revenue streams or any consumer based data points driven by the viewer activity. The current invention platform brings a unique user experience to the market allowing for new advantages based on new user experiences and solves user based needs related to impulse purchases of live TV highlights as well as solving new monetization and consumer data for the content producers and broadcasters.

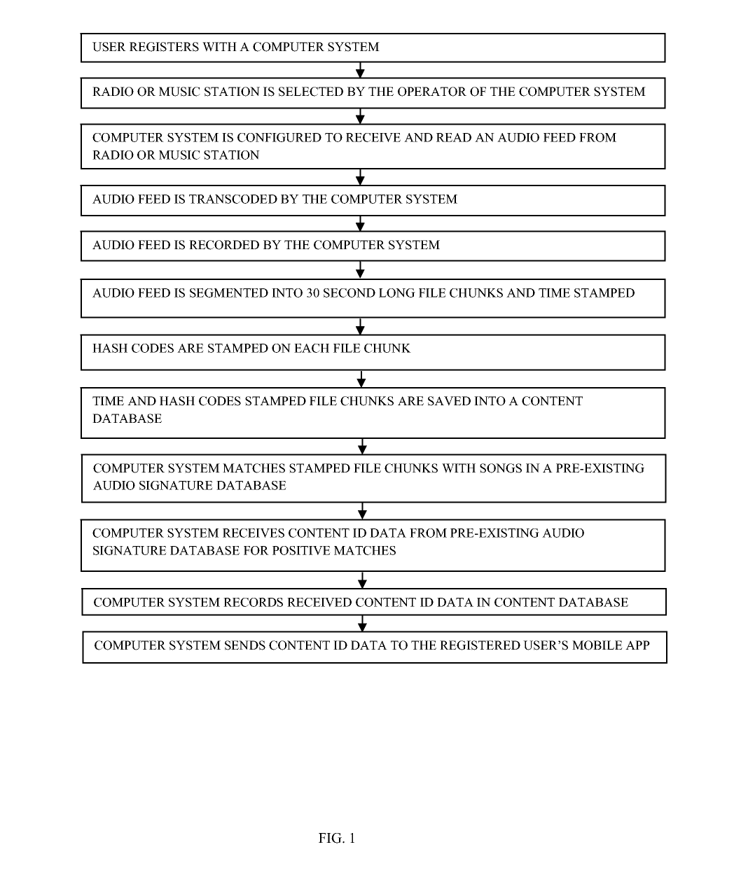

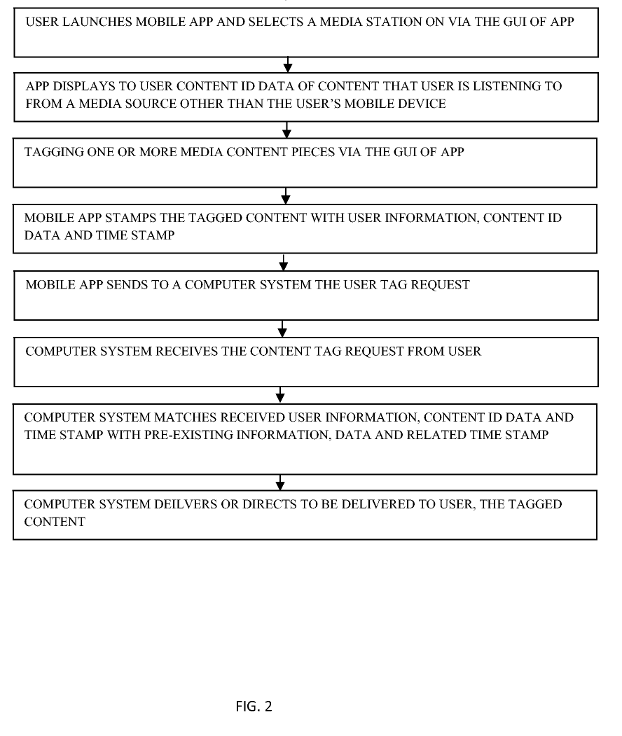

As illustrated in FIG. 1 and FIG. 2, in the first embodiment of the current invention, the user registers on the computer system in order to allow for the interactive experience to take place. The registration can take place via a Hypertext Transfer Protocol (“HTTP”) request, a short message service (“SMS”) message, radio frequency identification designation (“RFID”), near-field communication (“NFC”), optical signal locator (“OSL”) or other electrical, radio, optical or mechanical impulses. Users may also register via a mobile application or via existing identification credentials on social media networks such as Facebook and Twitter, and the identification information may include one or more of the following: a user electronic mail address, a user name, a user home address, a user telephone address, a user account number, and the like.

In this first embodiment the computer system integrates with any form of music radio station, including over-the-air AM/FM, cable, satellite, IP stream and TV station (over-the-air, cable, satellite or IP based). The computer system carries out automated real time music identification, on-the-fly, 24/7, and sends the metadata of all the tracks being identified from the preselected stations to a user mobile app, offering the user the opportunity to tag any track for download. The computer system integrates with a music radio station and identifies music by means of a transcoding/streaming server component that is installed in the computer system. The transcoding/streaming server is a generic server that can be bought in commerce. An example of such a server includes but is not limited to a DELL® OptiPlex 790 DT (469-0545) Desktop PC Intel Core® i5 2400 (3.10 GHz) 4 GB DDR3 500 GB HDD running Windows® 7 Professional 64-bit.

The transcoding/streaming server component includes an audio/video card. The audio/video card is a generic audio/video card that can be bought in commerce. An example of such a card includes but is not limited to the Genius® SoundMaker Value 5.1 V2 External Sound Card.

Digital streaming media software is installed on the transcoding/streaming server component to allow for reading incoming music stream. An example of such digital streaming media software includes but is not limited to VLC Media Player. A radio station or music TV station is selected by the operator of the computer system. Once a station is selected, a dedicated receiver is manually tuned to receive the broadcasting frequency of that station or, in the case of broadcasting via the internet, the online dedicated streaming URL of the station is configured directly on the transcoding/streaming server component in the computer system. The above mentioned dedicated receiver can be a satellite receiver if the preselected station is a station available via satellite or a cable set top box if the preselected station is a station available via cable. The satellite receiver is connected to the audio/video card. The digital streaming media software is configured to read the music content received by the audio/video card from the satellite receiver.

Once the stream of the media station is read by the digital media software, the streaming media software begins to transcode the stream in real-time; it converts the stream to a specified file format encoding (for example, mpeg stereo, sample rate 22,050 MHz at a bit rate of 48 kbps) for compression purposes and to prepare for real-time recording. The computer system is coded with software that instructs the computer system to record the binary stream produced by the streaming media software. Examples of such software include, but are not limited to Streaming Video Recorder, Jing®, and Debut®. The compressed, transcoded, binary stream of the media station is segmented, into 30 second file chunks and time stamped by the above mentioned software encoded into said computer system.

The computer system begins to carry out preprogrammed instructions to temporarily save each 30 second file chunk into a content database dedicated for each media station. The content database communicates with the computer system by being an integral component of the computer system or, by any suitable internet based protocol, if the content database is separate from the computer system. The relevant timestamp for each 30 second file is also captured and added to the database. A unique hash code for each 30 second file is also saved into the content database along with its relevant timestamp and media station ID. Third party software code is installed on the streaming server that is part of the computer system and is used to generate a unique hash code for each specific 30 second file that was recorded. The above mentioned 3rd party software code consists of one or more APIs that allow application developers to generate hash codes of captured audio files and compare them to pre-existing databases of audio signatures. Examples of such APIs include but are not limited to EchoNest® and Gracenote®. The hash code is a unique binary digital representation of the sounds captured in the 30 second file. Each unique hash code is the audio fingerprint of each 30 second file chunk.

Once the content database has one or more 30 second file chunks related to a pre-selected media station, and each 30 second file chunk has related timestamp and related hash code, the computer system then submits to a pre-existing database of hash codes (hereinafter also referred to as a “pre-existing audio signature database”), via hypertext transfer protocol (http), a “search for match” request for every hash code generated by the computer system. Once the matching hash code is found, all related content ID data about the song that was preset in the hash code content database is submitted back to the computer system. The computer system then saves the received content ID data about the song into the content database with the related 30 second file chunk. The computer system continuously receives all the content ID data and saves it for all the 30 second file chunks that were submitted and mapped against the pre-existing audio signature database. Accordingly, the computer system continuously populates the content database for each station with the relevant content IDs received and related timestamp of the identification process. The above mentioned content database contains content IDs and related timestamps. Finally, the computer system submits to the user's mobile app a continuous update of content ID data based on the process outlined above.

The above mentioned mobile app has the general features described below and can be easily developed by a person of ordinary skill in the art, using programming languages tailored for specific platforms. Programming languages include but are not limited to ActionScript®, HTML, HTML5, CSS, CSS3, Java®, JavaScript®, C, C++, Objective-C, C# NET/VB.NET, jQueryMobile, PhoneGap®, Visual Basic®. Platforms, include but are not limited to Adobe AIR®, Android®, App Inventor for Android, Appception, Appcelerator®, Appear IQ, Appery.io®, Basic4andrid, BREW, GeneXus®, IBM® Worklight, iOS® SDK, Java® ME, Python®, Windows® Mobile, windows Phone®. The above capturing, recording and identification process is carried out on the computer system in real-time in reference to the user's mobile app.

Once the user has acquired the mobile app onto his or her electronic device (a smart phone or tablet for example), the user can then launch the mobile app and finds a listing of preset radio and music TV stations for him to select from. The user selects, via the graphical user interface (GUI) of the mobile app, the logo of the radio or music TV station that he or she is listening to from another source such as a car radio or TV set. The app does not stream any audio of the selected stations. The app is a second screen experience whose purpose is to add value to existing media consumption habits and experiences.

Once a media station is selected by the user, the app begins to display to the user, in real-time, the full content ID data of the songs that he or she is hearing on the radio or TV. Also, because the computer system is continuously performing the identification process of all the preset media stations listed in the app, the app is able to offer the user the unique experience of navigating the full playlist of the radio station or the music TV station for the past 24 hours, allowing the user to access the complete playlist in chronological order starting with the latest song played and going back in time.

Because the complete content ID of the song is available, the user is able to “go back in time” in the playlist of any station on the app and enjoy a full interactive experience with any song, preview it, view the album artwork, purchase and download it at will.

When a user is emotionally moved by a track, he carries out an impulse based transaction via the app. He clicks on the “TAG” icon on the GUI of the mobile app, thereby tagging a particular song. The user's tag request contains user registration information, media source ID and a time stamp that defines when the user has tagged a particular piece of music. The mobile app may request the user to confirm tagging the song by displaying a CONFIRM icon on the app GUI. The user has the option to confirm tagging a particular song by clicking on the CONFIRM icon. The mobile app then sends to a computer system an http request based on the user action. The computer system receives the song tag request from the user, wherein the tag request contains the user registration information, media source ID and the timestamp of the TAG request.

The media source ID indicates to the computer system which content database it should access to search and match previously saved timestamps with the timestamp received in the TAG request. The computer system matches the above mentioned timestamps and identifies the specific user that is listening to a specific media station and tags a specific piece of content at a specific point in time. Accordingly, the computer system can determine who was exposed to which media station, what song was requested and when the request was made.

If the content that was tagged and identified by the computer system is sitting on the content servers within the computer system and the requested content ID is populated within the computer system, the computer system bills the user directly and delivers the tagged piece of content to the user electronic media device or other devices selected by the user.

If, on the other hand, the content that was tagged and identified by the computer system sits on a third party content aggregator server, based on the content ID the computer system has identified, the computer system redirects the user to the server of the third party and the third party bills the user and delivers the content to the user electronic media device or devices.

In an alternate embodiment of this invention, the user's electronic media device is replaced with a car entertainment system, allowing individuals in the car to select a radio station from the entertainment system, then tag and purchase specific content that has been pre-identified by the computer system.

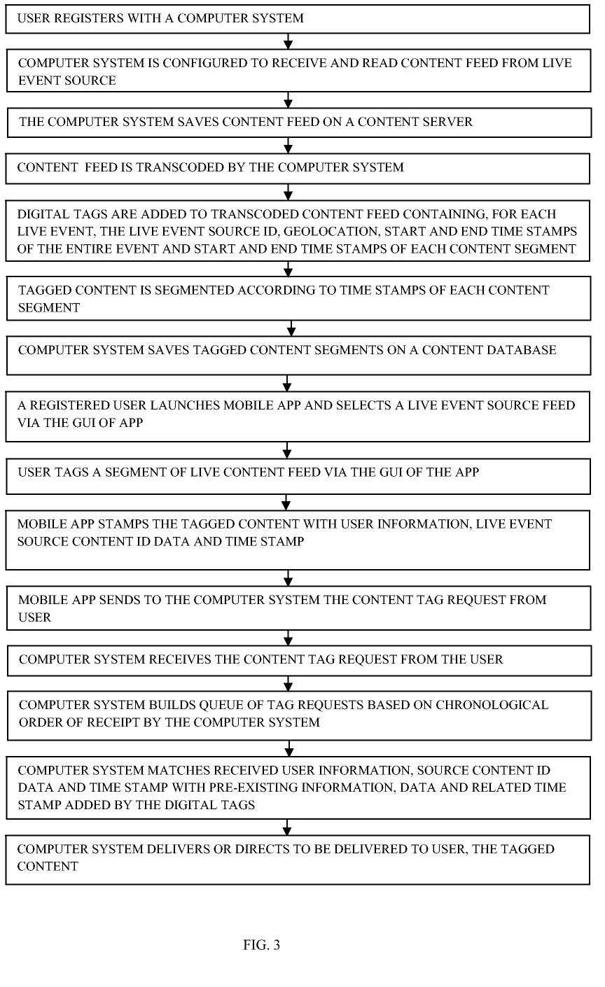

As illustrated in FIG. 3, in a second embodiment of this invention, the computer system integrates with any form of live venue, where audio/video content is broadcasted or distributed live. The user is exposed to this content in a live venue setting, such as a music concert, a sports event in an arena, a DJ in a club, restaurant or electronic dance music event, a rave, a magic show . . . etc

The content from a live event is captured and recorded in one of two ways:
The computer system is directly connected via the internet over http to the event production unit and the real-time audio/video content feed produces a content stream output from the event production unit which is in turn connected to the content editing server in the computer system. The content stream URL is configured on the content server and the content server begins to record the live content feed.

Or
The live event production unit makes a real-time digital recording of the audio/video feed on an external hard disk and this storage medium is then physically delivered post event to the location of the computer system where the digital file of the audio/video content of the live event is added to the content editing server on the computer system.

All actions that take place after recording the live content feed are carried out post live event. Each dedicated content stream related to a separate live event that was captured in one of the two methods outlined above is then transcoded by preinstalled media software on the content server for compression of file size and encoded into multiple file formats to support delivery to different electronic media devices. Examples of the above mentioned preinstalled media software includes but is not limited to VLC Media Player. Each dedicated content stream undergoes editing on the content editing server via software and manual human editors. The above mentioned editing process adds to the each dedicated content stream its relevant digital tags containing live venue source ID, geolocation, the related real-time start timestamp and the related real-time end timestamp of the full event and finally the “time markers” of the separate content segments within the full event.

The live venue source ID is the way the computer system separates the content streams it is receiving and the way the users are able to select which live venue they are attending from the pre-set venues listed in the mobile app. The geolocation comprises the GPS coordinates of the live venue to aid in the identification of the live venue in the computer system.

The above mentioned mobile app has the general features described below and can be easily developed by a person of ordinary skill in the art, using programming languages tailored for specific platforms. Programming languages include but are not limited to ActionScript, HTML, HTML5, CSS, CSS3, Java, JavaScript, C, C++, Objective-C, C# NET/VB.NET, jQueryMobile, PhoneGap, Visual Basic. Platforms, include but are not limited to Adobe AIR, Android, App Inventor for android, Appception, Appcelerator, Appear IQ, Appery.io, Basic4andrid, BREW, GeneXus, IBM Worklight, iOS SDK, Java ME, Python, Windows Mobile, windows Phone.

The captured content stream then undergoes an editing process by human editors, where the related real-time start timestamp and the related real-time end timestamp of the full event are added to the database. Separate time markers are then placed at the start of every new segment within the live event. The above mentioned human editors can use discretion and common sense in the placement of the above mentioned time markers. For example, time markers can be applied to define the beginning and end of each new song during a live concert. Similarly, time markers can be applied to define the beginning and end of a new scene in a stage production. After the time markers are applied by human editors the content segment is then broken up into separate files, where each segment is defined by the start and end timestamp of each content segment. The start time stamp applied by the human editors for one segment of the content stream is considered the end time stamp of the previous content segment. Each segment is saved by the computer system into a content database table dedicated to each live source.

Accordingly, the content database is populated with the live venue source ID and segment-separating time markers, the real-time start timestamp and real-time end time stamp of the full event along with the geolocation for each dedicated live event. At any time after the content database is populated as described above, the computer system receives and stores tag requests from users from their mobile apps. The computer system places all tag requests in a queue based on chronological order of time receipt.

The computer system continuously receives tag requests from users, building a queue of tag requests. A tag request contains user specific information, live event source ID and timestamp of the tag request. After the live event is finished and the captured content has been transcoded, time marked and populated into the content database with the relevant venue source ID, the computer system processes the queue of tags by mapping the timestamps of the tag requests against the start and end time marks that were created related to a specific venue source ID. Accordingly, the computer system identifies which of its registered users, tagged which particular content piece during which specific live venue and the corresponding specific content piece is delivered to the relevant user electronic media device. The computer system bills the user. In yet another embodiment, the billing process is carried out by a third party.

This exemplary embodiment is related to serve raves, music concerts, live shows, DJ mixes at clubs, and playlist mixes at restaurants and other live events, allowing consumers who are attending the live venues to tag specific pieces of content that they were exposed to at a live venue. Such content is unique, as it was specifically created and generated during that live scenario in real-time.

In this exemplary embodiment, the user is attending a live venue and this venue is integrated with the computer system. The user happens to like a track he or she are listening to during the live DJ mix at the venue they are attending where the DJ is mixing his music in real-time. The user can access the relevant mobile application and selects the logo of the venue that he is attending at that moment in time from a list of preset venues.

The above mentioned mobile app has the general features described below and can be easily developed by a person of ordinary skill in the art, using programming languages tailored for specific platforms. Programming languages include but are not limited to ActionScript, HTML, HTML5, CSS, CSS3, Java, JavaScript, C, C++, Objective-C, C# NET/VB.NET, jQueryMobile, PhoneGap, Visual Basic. Platforms, include but are not limited to Adobe AIR, Android, App Inventor for android, Appception, Appcelerator, Appear IQ, Appery.io, Basic4andrid, BREW, GeneXus, IBM Worklight, iOS SDK, Java ME, Python, Windows Mobile, windows Phone.

The application opens a venue specific page and displays to the user, via the app GUI, the logo of the venue and a TAG icon. The user simply presses on the TAG icon, which then sends a direct tag request to the computer system, containing the user information, the venue ID and timestamp of the tag request. Once the relevant content has been captured, transcoded, time marked and populated into the content database, the computer system maps out the timestamps of the received tags in the queue with the time markers of the captured content, and is able to identify who of the registered users, requested which specific piece of content from which specific venue and accordingly delivered that content piece to the relevant user electronic media device post event.

The app does not stream any audio of the selected live events in real-time. The app is a second screen experience that adds value to existing live event user consumption habits and experiences.

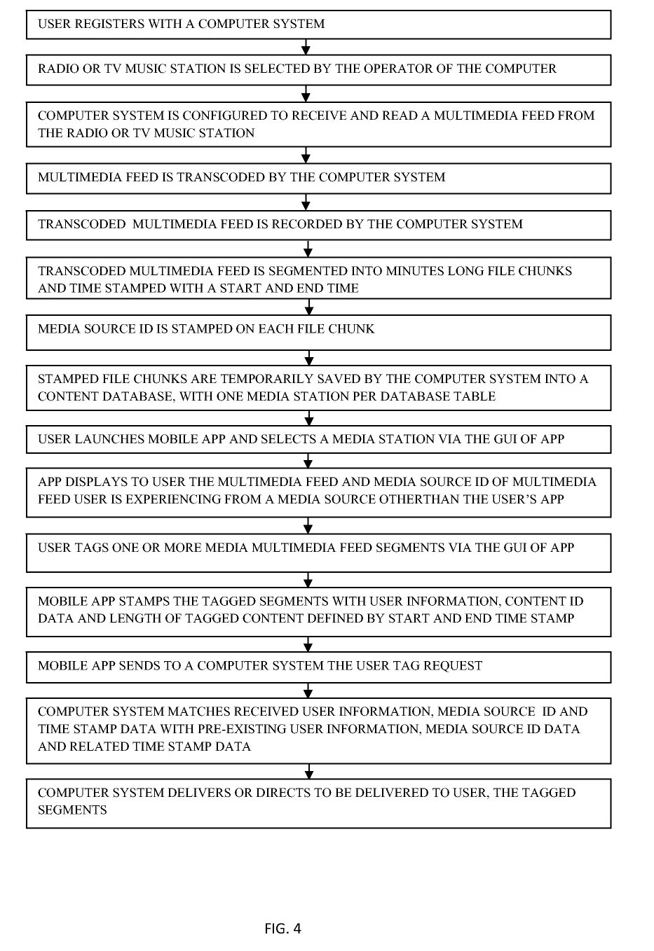

As illustrated in FIG. 4, in a third embodiment of this invention, the computer system plays the same role that video cassette recorders (VCRs) played when individuals would record live TV to VHS cassettes in order to keep what they considered to be “highlights” to be shared socially. This embodiment does not capture long form content, but is limited to capture only short form multimedia content, to be shared across social media networks. Short form multimedia content is typically under 5 minutes in length.

In this exemplary embodiment the user is exposed to the content via a conventional media source such as his TV. The user decides what he considers to be “highlight moments” that he wishes to capture in real-time off the TV station he is watching to share via social media networks.

In this embodiment the computer system captures and records any form of audio/visual content distribution media forms, whether over-the-air, cable, satellite, or IP stream. The computer system contains a transcoding/streaming server component that operates a digital streaming media software to allow for reading the incoming media feed. The streaming server component is a generic server that can be bought in commerce. An example of such a server includes, but is not limited to a DELL OptiPlex 790 DT (469-0545) Desktop PC Intel Core i5 2400 (3.10 GHz) 4 GB DDR3 500 GB HDD running Windows 7 Professional 64-bit. The transcoding/streaming server component includes an audio/video card. The audio/video card is a generic audio/video card that can be bought in commerce. An example of such a card includes but is not limited to the Genius SoundMaker Value 5.1 V2 External Sound Card.

A radio station or music TV station is preselected by the computer system operator. Once a station is selected, a dedicated receiver is manually tuned to receive the broadcasting frequency of that station or, in the case of a broadcasting via the internet, the online dedicated streaming URL of the station is configured directly on the transcoding/streaming server component in the computer system. The above mentioned dedicated receiver can be a satellite receiver if the preselected station is a station available via satellite or a cable set top box if the preselected station is a station available via cable. The satellite receiver is connected to the audio/video card. The digital streaming media software on the transcoding/streaming server component in the computer system is configured to read the content received by the audio/video card from the dedicated receiver. An example of such digital streaming media software includes but is not limited to VLC Media Player.

Once the stream of the media station is read by the media software, the streaming media software begins to transcode the stream in real-time; it converts the stream to a specified file format encoding (for example mpeg stereo, sample rate 22,050 MHz at a bit rate of 48 kbps) for compression purposes and to prepare for real-time recording. The computer system then records the binary stream produced by the streaming media software. The compressed, transcoded, binary stream of the media station is segmented and separated into file chunks and time stamped by the above mentioned computer system with a start and end time stamp. Each file is a few minutes long.

Each file is temporarily saved by the computer system into a content database table dedicated to each media station. The content database holds the segmented content streams of all captured channels. Each media station, however, has a dedicated table, within the content database. The relevant timestamp for each 3 minute file is also captured and added to the content database.

The content database is populated on a per channel basis with a unique media source ID, and every file representing a content stream segment includes the start time stamp and end time stamp and is saved in the content database. The database for each channel is populated for 24 hours, before it is deleted and the capturing process begins again for the next 24 hours. The content database is then ready to receive tag requests from the users.

The user can obtain a specific file representing a content stream segment using a mobile app operating on the user's mobile device. The above mentioned mobile app has the general features described below and can be easily developed by a person of ordinary skill in the art, using programming languages tailored for specific platforms. Programming languages include but are not limited to ActionScript, HTML, HTML5, CSS, CSS3, Java, JavaScript, C, C++, Objective-C, C# NET/VB.NET, jQueryMobile, PhoneGap, Visual Basic. Platforms, include but are not limited to Adobe AIR, Android, App Inventor for android, Appception, Appcelerator, Appear IQ, Appery.io, Basic4andrid, BREW, GeneXus, IBM Worklight, iOS SDK, Java ME, Python, Windows Mobile, windows Phone.

Once the user acquires the mobile app, the mobile app shows him a list of pre-set TV stations to choose from. The user can select, on the mobile app, from the list of preset channels uploaded on the mobile app, the radio or TV channel he or she happens to be viewing at a particular time. Once a selection is made, the user is then taken to the dedicated radio or TV channel page on the app. The user can then capture a particular content piece, or highlight, what he views in real time on the TV or other audio/visual media source. The user captures such highlight by simply pressing a TAG icon on the mobile app GUI. The pressing of the TAG icon is a tag request.

The app allows the user to select content dated anywhere from 30 seconds before and up to 3 minutes after the timestamp of the tag request. The user is able to adjust the time length of the captured video via a time slider displayed on the GUI of the app. Once the user has selected a specific length of content, the user confirms his selection by pressing a TAG icon on the app GUI. The user's electronic media device then transmits the tag request via http to the computer system. The computer system receives a tag request from a registered user, the TAG request received from the mobile app by the computer system contains the full user info, and media source ID, the timestamp of the TAG request and the requested length of the content file. The tag request contains a media source ID.

The media source ID indicates to the computer system which content database it should access to search and match previously saved timestamps with the timestamp received in the tag request. The computer system matches and identifies which user was watching a particular media station and the length of the content segment tagged at a particular point in time. Accordingly, the computer system can determine who was exposed to which media and requested what length of video content, and when the request was made. Software code on the computer system carries out an automated editing process to capture the exact length of video content that the user requested as per the data in the user tag request. The computer system bills the user directly and delivers the tagged piece of content to the user electronic media device for sharing across social media.

The computer system receives a tag from a registered user, the tag contains user info, and media source ID and the timestamp of tag along with the length of the video capture as per the user request on the time slider. The computer system processes the information in the tag received and maps the timestamps of the tag against the timestamps created in the content database, allowing the computer system to determine which user was watching which media station and tagged which piece of content at what point in time for how much time. If a user has selected a video length that falls between two file chunks in the database, the computer system stitches two file chunks together and edits it them on the fly to offer the exact video file length and selection that the user requested based on the information that was in his tag request.

The app does not stream any audio or video of the selected TV stations. The app is a second screen experience there to add value to existing media consumption habits and experiences.

1. A method for provision of content data comprising:
registering a user by recording a user's identifying information, wherein said recording is done by a computer system;
selecting a radio or music station by an operator of said computer system;
configuring said computer system to receive and read an audio feed from said radio or music station;
transcoding said audio feed by said computer system;
recording said audio feed by said computer system;
segmenting said audio feed into 30 second long file chunks by said computer system;
time stamping each said file chunk by said computer system;
stamping each said file chunk with hash codes by said computer system;
saving said time and hash codes stamped file chunks by said computer system into a content database;
matching, by said computer system, said time and hash codes stamped file chunks with songs in a pre-existing audio signature database;
receiving, by said computer system, content identification data from said pre-existing audio signature database;
recording, by said computer system, said received content identification data in said content database; and
sending, by said computer system, said content identification data to a mobile application located on a mobile device of said registered user.

2. The method of claim 1 further comprising:
launching said mobile application on said mobile device by said registered user;
selecting a media station via the graphical user interface of said application by said registered user;
displaying to said registered user, on said mobile application, said content identification data of said content that said registered user is listening to from a source other than said mobile device of said registered user;
tagging one or more media content pieces by said registered user using the graphical user interface of said mobile application;
stamping said tagged media content pieces by said mobile application with said registered user's information, identification of said content data and time stamp;
sending to said computer system said registered user's information, identification of said content data and time stamp;
receiving by said computer system said registered user's information, identification of said content data and time stamp;
matching by said computer system said received user information, content identification data and time stamp with said recorded user's identifying information, content identification data and time stamp; and
delivering by said computer system to said registered user, said tagged one or more media content pieces.

3. A method for provision of content data comprising:
registering a user by recording a user's identifying information, wherein said recording is done by a computer system;
configuring said computer system to receive and read multimedia content from a live event source;
recording by said computer system said content on a content server;
transcoding said content by said computer system;
adding digital tags to said transcoded content wherein said digital tags contain at least one of the following: identification data for said live event source, geolocation of said live event source, start and end time stamps of entire said content and start and end time stamps of each pre-existing segments of said content;
segmenting, by said computer system, said tagged content according to said start and end time stamps of each pre-existing segments of said content; and
saving said segmented tagged content on a content database by said computer system.

4. The method of claim 3 further comprising:
launching a mobile application by said registered user on a mobile device;
selecting a live event source feed by said registered user using the graphical user interface of said mobile application;
tagging a segment of said live event source feed by said registered user using said graphical user interface;
stamping, by said mobile application, said tagged segment with registered user's information, live event source content identification data and time stamp;
sending by said mobile application to said computer system, said registered user's information, live event source content identification data and time stamp;
receiving by said computer system, said registered user's information, live event source content identification data and time stamp;
building a queue by said computer system of said received registered user's information, live event source content identification data and time stamp, wherein said queue is based on the chronological order of receipt by the computer system of said received registered user's information, live event source content identification data and time stamp;
matching by said computer system said received registered user's information, live event source content identification data and time stamp with said recorded user identifying information, said identification data for said live event source and said start and end time stamps for each said segments of said content; and
delivering by said computer system to said registered user, said tagged segment.

5. A method for provision of content data comprising:
registering a user by recording a user's identifying information, wherein said recording is done by a computer system;
selecting a radio or TV music station by an operator of said computer system;
configuring said computer system to receive and read a multimedia feed from said station;
transcoding said feed by said computer system;
recording said feed by said computer system;
segmenting said recorded feed into segments;
stamping said segments with a start and an end time and with identification information of said station; and
temporarily saving by said computer system, said stamped segments in a content database table.

6. The method of claim 5 further comprising:
launching by said registered user a mobile application;
selecting by said registered user a radio or TV music station using the graphical user interface of said mobile application;
displaying to said registered user said multimedia feed and said identification information of said selected station;
tagging by said registered user one or more segments of said multimedia feed using said graphical user interface of said mobile application;
stamping said tagged segments, by said mobile application, with said registered user information, said identification information of said station and description of length of tagged segment, wherein said length is defined by a start and an end time;
sending, by said mobile application, said stamped registered user information, said identification information of said station and said description of length of tagged segment to said computer system;
matching, by said computer system, said sent registered user information, said identification information of said station and said description of length of tagged segment to said computer system with said recorded user identifying information, said computer system stamped identification information of said station and said computer stamped start and end time of said segments; and
delivering to registered user said registered user tagged segments.

7. The method of claim 6 wherein said segments of said multimedia feeds from two or more stations are temporarily saved by said computer system in separate content database tables.
